(19) United States
(12) Patent Application Publication
(10) Pub. No.: US 2009/0120047 A1
(43) Pub. Date: May 14, 2009

(54) CEILING MOUNTED AIR DECONTAMINATION AND PURIFICATION UNIT

(75) Inventors: Aymeric PERRIER, Trevoux (FR); Vivien DARRACQ, Montigny-le (FR)

Correspondence Address: Beyer Law Group LLP, P.O. BOX 1687, Cupertino, CA, 95015-1687, US

(73) Assignee: AirInSpace BV, Delft (NL)

(21) Appl. No.: 11/939,424

(22) Filed: Nov. 13, 2007

(51) Int. Cl. B01L 1/04; B01D 46/00; B01J 19/08

(52) U.S. Cl. 55/471; 204/164; 422/186.04; 454/187

(57) ABSTRACT

A ceiling-mounted air-treatment unit is described. The unit includes an inlet air duct arranged to receive an inflowing air stream, a ceiling mounted plasma reactor for filtering and biologically decontaminating the air stream as it passes through the reactor, and an outlet duct for discharging treated air into a room requiring a sterile environment. The plasma reactor includes a plasma generator, an electrostatic filter, and optionally a catalyst to remove reactive species from the treated airflow. Additionally, the plasma reactor is arranged in a ceiling mounted frame that arranges the plasma reactor in an operating position in the ceiling and is movable to a service position where the plasma reactor can be moved downward into the sterile room for maintenance and servicing.

### BACKGROUND OF THE INVENTION

The present invention relates generally to ceiling mounted air decontamination and purification units suitable for use in sterile environments such as medical operating rooms and other rooms that require filtered and biologically clean air.

There are currently a wide range of technologies that are used to decontaminate, purify and/or filter air. Within building structures (e.g., commercial buildings, hospitals, residential dwellings, etc.) the purification and filtering systems are sometimes built into a central heating, air conditioning and ventilation (HVAC) system. Although central air filtering systems work well in many applications, in surgical environments it is desirable to provide a higher level of air treatment in a particular room than is available in current central air treatment systems. Specifically, although central HVAC systems often include some level of filtering, they rarely incorporate much, if any air purification or decontamination abilities. Additionally, some buildings structures do not have central HVAC systems. Therefore, there are a wide variety of applications where it is desirable to provide an air filtering, purification and/or decontamination unit that is suitable for treating the air in a room.

In many applications, it is very desirable to provide a room air treatment system that is arranged to inactivate (i.e. kill) airborne biological objects (e.g., microorganisms and viruses) in addition to filtering the air. It some applications, it is desirable to provide a room air handling unit that can effectively remove volatile organic compounds (VOCs) for health or comfort reasons. There are also a number of applications that require a high level of filtering (e.g., HEPA or ULPA filtering) for the room. Of course, there are a number of applications in which it is desirable to provide two or more of these features.

There are a variety of room air treatment systems that are designed to perform these types of air decontamination, purification and/or filtering tasks. Some room air treatment systems are mobile devices that can be placed at any desired location within a room. By way of example, plasma based transportable room air treatment systems that are well designed for filtering and biologically decontaminating rooms are described in commonly assigned U.S. patent application Ser. No. 11/580,477 and International Application No. PCT/FR04/02309, (which corresponds to U.S. application Ser. No. 10/571,558), all of which are incorporated herein by reference. Although these systems work well in a wide variety of applications, it is sometimes desirable to build the air treatment system into the room itself.

Therefore, there are a variety of room air treatment systems that are designed as fixtures that are intended to be built into the room. Some such systems (typically simpler systems) are mounted onto a wall while others may be mounted on the ceiling. In environments such as hospital operating rooms it may be particularly desirable to utilize ceiling based air treatment systems in part because such systems permit the cleanest air to be directed towards the patient without requiring the air treatment system to occupy valuable space within the operating room that is close to the patient.

Most of the conventional mounted room air treatment systems are primarily designed to filter the air. A few designs have used technologies such as ion enhanced electrostatic filtering in an attempt to inactivate (i.e. kill) at least some of the biological objects (e.g., microorganisms and viruses) that may be carried in the air stream in addition to filtering particulates from the stream. However, it is believed that the bio-decontamination efficacy of such conventional systems has not been particularly good. Therefore, in many environments (such as hospital operating rooms) it would be desirable to provide better biological decontamination of the incoming air than is currently available in ceiling mounted room treatment system. Additionally, many in-ceiling air treatment systems are difficult to service when it comes time to change, repair or replace the working components of the system.

Therefore, although the prior art room air treatment systems work well in a number of applications, there are continuing efforts to provide improved air purification and/or filtering devices that can meet the needs of specific applications.

### SUMMARY OF THE INVENTION

A variety of improvements suitable for use in air treatment systems are described. In one aspect of the invention, a ceiling mounted air treatment system includes an inlet duct that receives an air stream from a central air handling system. The air stream received from the inlet duct passes through an air inlet of a plasma reactor arranged in the ceiling to filter and biologically decontaminate the air stream as it passes through the reactor. The treated air stream passes out of the reactor through an outlet into a plenum coupled to the outlet. The plenum being configured to discharge the treated air into a room. The inlet duct, the plasma reactor, the outlet and the plenum, are all located in the ceiling of a room to save space and enable treated air delivery into the room. The system is configured to enable an airflow path that extends between the inlet duct and the outlet with a number of components arranged in the airflow path. For example, in many embodiments, a first element arranged in the airflow path is a plasma generator, a second element is an electrostatic filter, and a third element is a catalyst. The system is advantageously configured such that the various air-treatment components of the system ( e.g. plasma reactor) operates in the ceiling but can also be lowered into a room for maintenance.

An in-ceiling air-treatment system with a plasma reactor that filters and can biologically decontaminate an air stream passing through the plasma reactor is arranged to treat air and deliver it from the ceiling of the room via the system that houses the air treatment system. The plasma reactor is mounted in the ceiling with a mounted frame that facilitates the movement of the plasma reactor from an operating position that positions the plasma reactor in the ceiling of the room and is movable to a servicing position that moves the plasma reactor to a location substantially within the room where it can more readily be accessed for servicing from within the room.

In another aspect of the invention, a clean room having an in-ceiling air treatment system is described. The room has a ceiling and walls with an air treatment system mounted in the ceiling. The air treatment system includes an air ventilation system for providing an inflowing airflow to the air treatment system and a plenum for discharging treated air into the room. A frame arranged in the ceiling to support an inlet duct, an outlet duct, and a movable plasma reactor. The frame is configured to include a fixed mounting bracket secured to the ceiling and a movable support bracket pivotably attached to the fixed mounting bracket. When in the operational position the movable support bracket supports the plasma reactor in the ceiling so that it can receive the airflow from the central air system through an inlet duct of the unit and so that it can discharge treated air into the plenum through an outlet duct of the unit. Additionally, the movable support bracket is further configured so that it can be readily moved to a service position enabling the plasma reactor to be moved into a position lying inside the room enabling easy access to the plasma reactor from inside the room.

### BRIEF DESCRIPTION OF THE DRAWINGS

The invention and the advantages thereof, may best be understood by reference to the following description taken in conjunction with the accompanying drawings in which:

FIG. 1 is a diagrammatic view of an air treatment system in accordance with one embodiment of the present invention;

FIGS. 2A-2G are diagrammatic perspective views of the air treatment system illustrated in FIG. 1 depicting the process of moving the plasma reactor from a service position to a sealed operating positing;

FIG. 3 is a diagrammatic side view of the movable support bracket in the maintenance position showing the trays supported by the sets of support tabs or rails in accordance with an embodiment of the invention;

FIG. 4A is a diagrammatic front perspective view of a stack of trays suitable for holding an embodiment of a plasma reactor in accordance with the principles of the invention;

FIG. 4B is a diagrammatic side perspective view of the stack of trays such as is shown in FIGS. 4A, 4C, & 4D;

FIG. 4C is a plan view of the top tray shown in FIG. 4B;

FIG. 4D is an exploded perspective view of the stack of trays such as is disclosed in this patent and as shown in FIGS. 4A-4D;

FIGS. 5A-5C provide a diagrammatic side view of the frame highlighting the pivotable motion of the support bracket and plasma reactor from the raised operating position to the lowered service position in accordance with an embodiment of the invention.

In the drawings, like reference numerals are sometimes used to designate like structural elements. It should also be appreciated that the depictions in the figures are diagrammatic and not to scale.

### DETAILED DESCRIPTION OF THE PREFERRED EMBODIMENTS

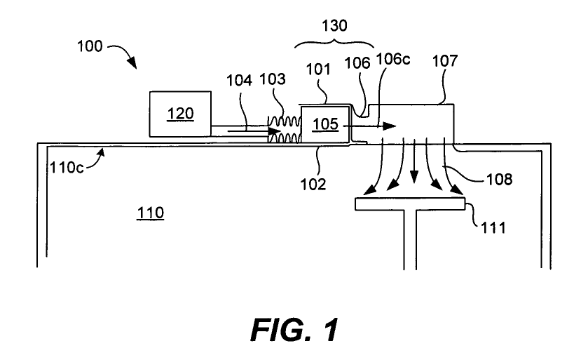

The present invention relates generally to ceiling mounted room air treatment systems, although some of the described components may be used in other air-treatment systems as well. In particular, applications of the presently described invention relate specifically to ceiling-mounted air-treatment systems adapted for use in surgical operating rooms. A ceiling-mounted room air-treatment system 100 in accordance with one embodiment of the present invention is illustrated in FIG. 1. In the depicted embodiment, an inflow of air 104 is supplied to a ceiling mounted plasma reactor 105 which filters and biologically decontaminates the air and then directs the air into a clean environment such as a surgical operating room 110. In one embodiment, the plasma reactor 105 of the present invention is supported in a ceiling 110c by a movable frame system 101, 102 that enables the reactor to be moved from an operating position in the ceiling to a servicing position in the room. In the ceiling-mounted operating position (diagrammatically depicted in FIG. 1), the reactor can treat the incoming air and discharge the treated air 108 into the room 110. The reactor can easily be moved into a servicing position that enables the plasma reactor to be much more easily accessed from inside the room.

With further reference to FIG. 1, an air treatment system 100 is schematically depicted and described. The system 100 includes a ceiling-mounted unit arranged in the ceiling 110c of a room 110 intended to be clean. In one particular example, the room 110 is a surgical operating room. In another embodiment, the inventors contemplate that the clean room 110 comprises a semiconductor processing clean room capable of operating semiconductor processing and inspection machines. In general, the inventors point out that although the systems disclosed here are ideal for operating room environments and also for clean semiconductor processing and inspection environments, the inventions disclosed herein are well suited for use in all rooms requiring a clean and/or biologically decontaminated environment.

With continued reference to FIG. 1, the system 100 includes a frame or housing 130 for holding a plasma reactor 105 that treats inflowing air prior to introduction into a clean environment as described herein. In the depicted embodiment the housing 130 includes a movable support bracket 101 for holding the plasma reactor 105 and a fixed mounting bracket frame 102 which mounts the housing 130 and plasma reactor 105 to a ceiling 110c. In the depicted embodiment, the movable support bracket 101 is pivotably mounted with the fixed mounting bracket 102 to enable the plasma reactor 105 to move from an operating position (where it can be used to treat air prior to introduction into the room) to a servicing position that enables easier access to the plasma reactor from inside the room 110. The inventors point out that the movable support bracket 101 is specifically arranged so that when the movable bracket 101 is moved the plasma reactor 105 is moved from one position to the other.

In the depicted embodiment, the fixed mounting bracket 102 includes an air inlet duct 103 and an air outlet duct 106 arranged to facilitate air flow through reactor 105. Although depicted here as components integrated with the fixed mounting bracket 102, the inlet duct 103 and outlet duct 106 can be separate components or be attached to other elements of the system. As shown here, the plasma reactor 105 is coupled with an air source 120 using, for example, an air inlet duct 103 that allows inlet airflow 104 into the air plasma reactor 105 from the air source 120 (like a central air system or other external air flow system). The plasma reactor 105 is further coupled with an air outlet duct 106 to enable the treated air 106a to be delivered into the room 110 from the ceiling 110c. For example, the air treatment unit 101 can exhaust treated air 106 into a plenum 107 configured to vent treated air downward (indicated by 108) into the room 110. In one embodiment, the treated air 106a, 108 can be directed downward on to an area intended to have a high degree of sterility. Examples include, but are not limited to, surgical fields or an operating table 111. The plenum can be constructed with a plurality of vents across its bottom surface to enable efficient downward airflow 108. In one example, a porous fabric is used on the bottom surface of the plenum to direct the treated air down into the room or onto a selected site (e.g., an operating table 111).

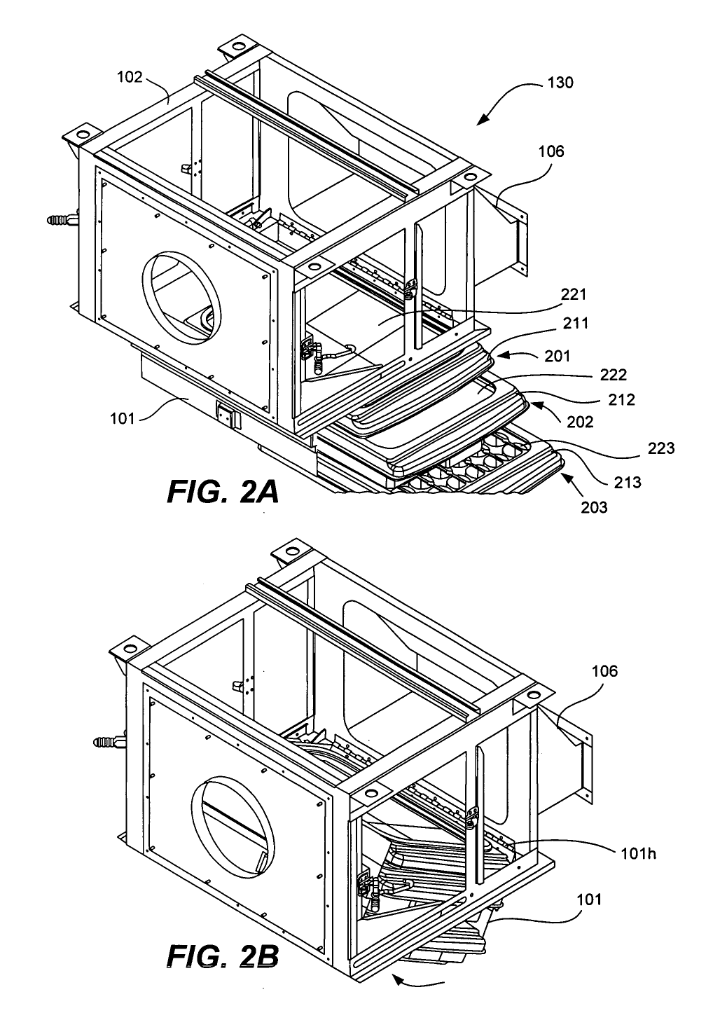

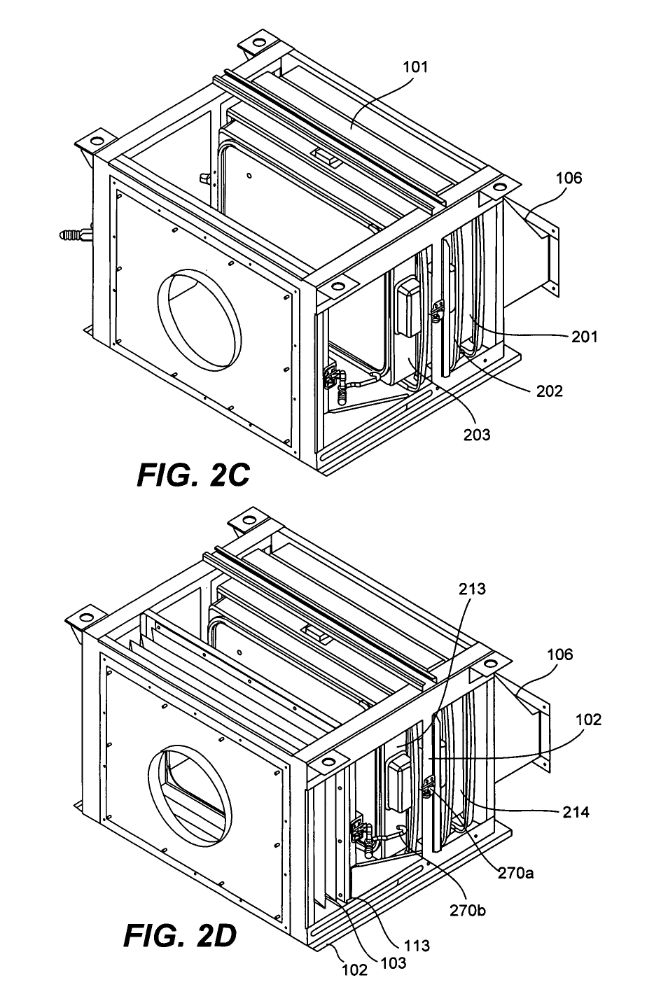

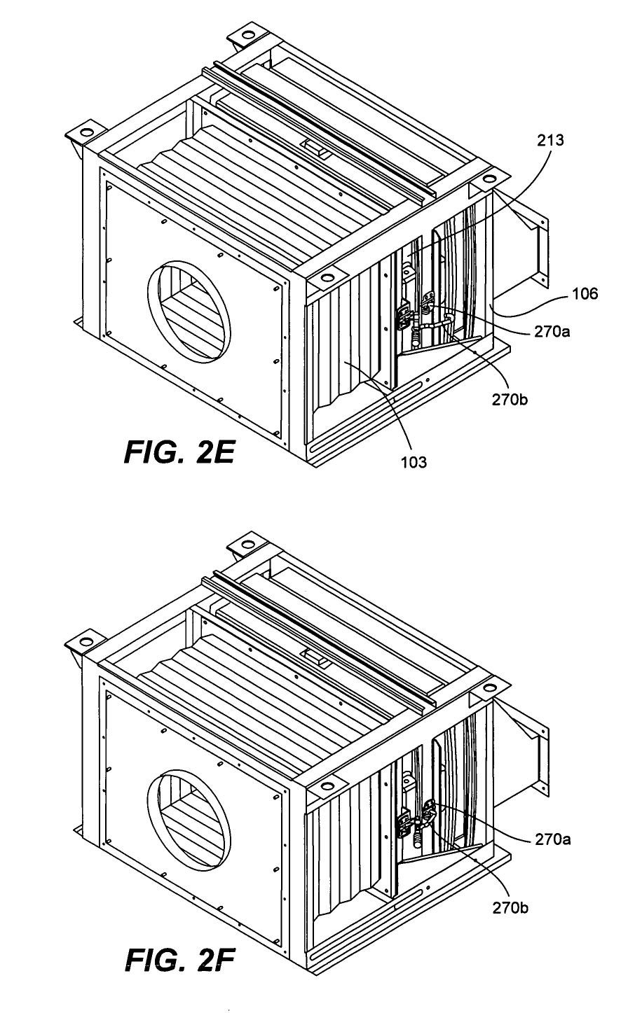

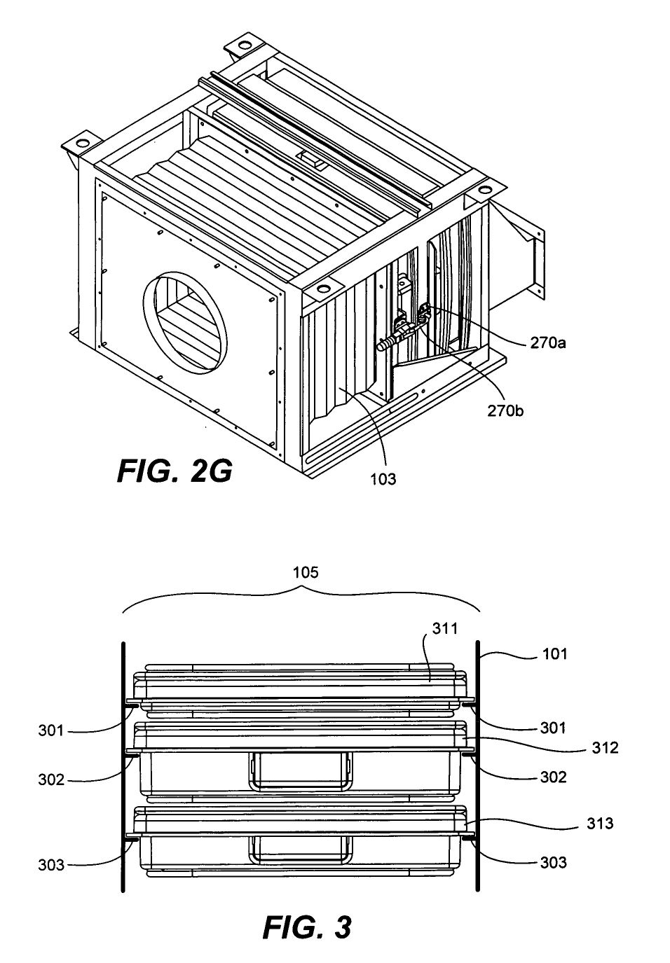

FIG. 2A depicts an embodiment of the plasma reactor housing 130. The depicted housing 130 includes a fixed mounting bracket 102 in pivotable arrangement with a movable support bracket 101. The fixed mounting bracket 102 supports the movable support bracket 101 in a ceiling. Additionally, the movable support bracket 101 holds various components 201, 202, 203 of the plasma reactor. The movable support bracket 101 is configured to enable the reactor components 201, 202, 203 to be moved from an operating position to an easily accessible service position. Accordingly, the housing 130 is used to move the plasma reactor from a service position (as depicted in FIG. 2A) to and from an operating position where the components are raised and sealed inside the housing 130.

The fixed mounting bracket 102 secures the plasma reactor components and the movable support bracket 101 to the ceiling. Moreover, the fixed mounting bracket 102 supports the movable support bracket 101 as it moves the plasma reactor components (201, 202, 203) to a servicing position as needed. Rather that being limited to ceiling implementations, in other embodiments, the fixed mounting bracket 102 can be mounted in any desired orientation to fix the plasma generator components in place when operational. Here, the movable support bracket 101 is mounted directly to the bottom of the fixed mounting bracket 102 such that it can be moved inside the fixed bracket 102 to enable operation of the reactor. Also, in this view, the movable support bracket 101 is depicted in a service configuration where the bracket 101 is pivotably rotated downward into the service position so that the plasma reactors components 201, 202, 203 extend downward from the ceiling into the room for easy access and maintenance.

In the depicted embodiment, the plasma reactor components are supported in the movable support bracket 101 by a plurality of component trays (e.g., 211-213). It should be pointed out that each tray 211-213 can hold one or more different components and any number of trays can be employed. For example, in the depicted embodiment, tray 213 can hold a plasma generator 223 configured to produce reactive species. Examples of such plasma generators are described in detail, for example, in patent applications Ser. Nos. 11/407,236 and 11/830,556 which are hereby incorporated by reference. In the depicted embodiment, the plasma generator 223 is arranged as a plurality of parallel plasma generation cells each capable of producing reactive species. The inventors contemplate that many plasma generation devices and configurations may be employed to generate reactive species in accordance with the principles of the invention. A next tray 212 can, for example, hold an electrostatic filter 222 configured to filter air passing through the filter 222. Also, if desired, an optional tray 211 can be employed to hold a catalyst, absorber or combination of the two 221 configured to capture reactive species as they emerge from the filter 222 and remove them from an outgoing airflow. In one embodiment, a suitable catalyst is manganese oxide (MnO₂). For example, the catalyst can be a block with a multitude of air-flow holes and treated such that at least the surface of the block is coated with catalyst. Moreover, in other embodiments additional trays having added catalysts can be employed. In one embodiment, an added tray can be located upstream from the first catalyst (e.g., upstream from the MnO₂ catalyst). This second catalyst can include oxidation catalysts that enable the creation of even more reactive species (e.g., ozone). Such oxidative catalysts are numerous including, but not limited to materials such as TiO₂, BaTiO₃ and others. In some implementations these added reactive species have been shown to demonstrate more effective biological decontamination of contaminants in the air stream. Additionally, such added reactive species can also be removed by the first catalyst (e.g., MnO₂) which is down stream. In other applications any of the described trays and/or additional trays may be used to house other reactor components including, for example, pre-filters, UV light generators, absorbers, etc.

FIG. 3 depicts a side view of the movable support bracket 101 with a plurality of trays 311, 312, 313 held in the bracket 101. In this embodiment, the movable support bracket 101 is shown as in the servicing position, that is to say suspended downward into the room for servicing. The movable support bracket 101 includes tray support features. For example, in the depicted embodiment, a multiplicity of support tabs are configured as sets of support tabs 301, 302, 303 for supporting the trays 311, 312, 313. Each set of tabs are configured to support an associated tray (and the reactor elements loaded therein) in the movable support bracket 101. For example, a first set of tabs 301 supports a first tray 311, a second set of tabs 302 supports a second tray 312, and so on for each tray. These tabs are arranged such that when the movable support bracket 101 is moved into the servicing position (as shown) the trays 311, 312, 313, are suspended from the tabs. In the depicted embodiment, each tray (311, 312, 313) includes small ledges located at the edges of the trays which engage the bracket support tabs 301, 302, 303 when the bracket 101 is lowered. In some embodiments, the trays separate from each other in a spaced apart arrangement as the movable support bracket 101 is lowered into the servicing position. This enables the trays to be easily slid into and out of the movable support bracket 101 for easy maintenance access to the trays and associated reactor elements. In some embodiments, the support tabs 301, 302, 303 can comprise simple pins arranged to support the trays as needed. In other embodiments the support tabs 301, 302, 303 can comprise pairs of rails arranged, for example, one on either side of the bracket 101 to support each tray. Such embodiments provide excellent support for the trays as the bracket is moved into the service position and allow easy access to the trays and the reactor elements contained therein.

Returning to FIG. 1, a mode of operation for the depicted embodiment is disclosed. Incoming air 104 is introduced into the system where it is channeled into the plasma reactor 105 for treatment. As indicated above, the incoming air 104 can be generated by a central air system or other ventilation system. In many embodiments, the air can be optionally passed through a mechanical filter prior to entry to the system 130. The air 104 is then passed through an inlet duct 103 into the plasma reactor 105. After passing through the plasma reactor 105 the treated air 106c passes into an outlet duct 106 where it can be discharged into the operating room 110. In other embodiments, other air-treatment systems including ion enhanced electrostatic filters, UV based air treatment systems, mechanical HEPA or ULPA filters, etc. may be used in place of the plasma reactor 105 shown here. After exiting the plasma reactor 104, the air stream 106c passes through duct 106 to the air outlet 107 (for example, a plenum) which is configured to permit the outlet air stream 108 to be directed in a desired direction (e.g. onto an operating table or sterile surgical field).

Sealed internal ducting is provided as necessary within the system so that the airflow path from inlet duct 103, through plasma reactor 105, through outlet duct 106, into air outlet 107 is sealed and prevents the entry of contaminated air. Moreover, the seal ensures that all of the air entering the system flows through the reactor 105 where it can be treated. This sealing is important to reduce the probability that contaminated or unfiltered air will be drawn into the outlet air stream.

In the illustrated embodiment, the air treatment unit utilizes a plasma reactor 105. Each reactor 105 includes a stack of trays (e.g., 211, 212, 213), with each tray housing one or more components of the reactor. The components of the plasma reactor may be varied to meet the needs of a particular application. By way of example, suitable reactor configurations are described in U.S. patent application Ser. No. 11/407,236 filed Apr. 18, 2006 and 60/836,895, filed Aug. 9, 2006, which are incorporated herein by reference.

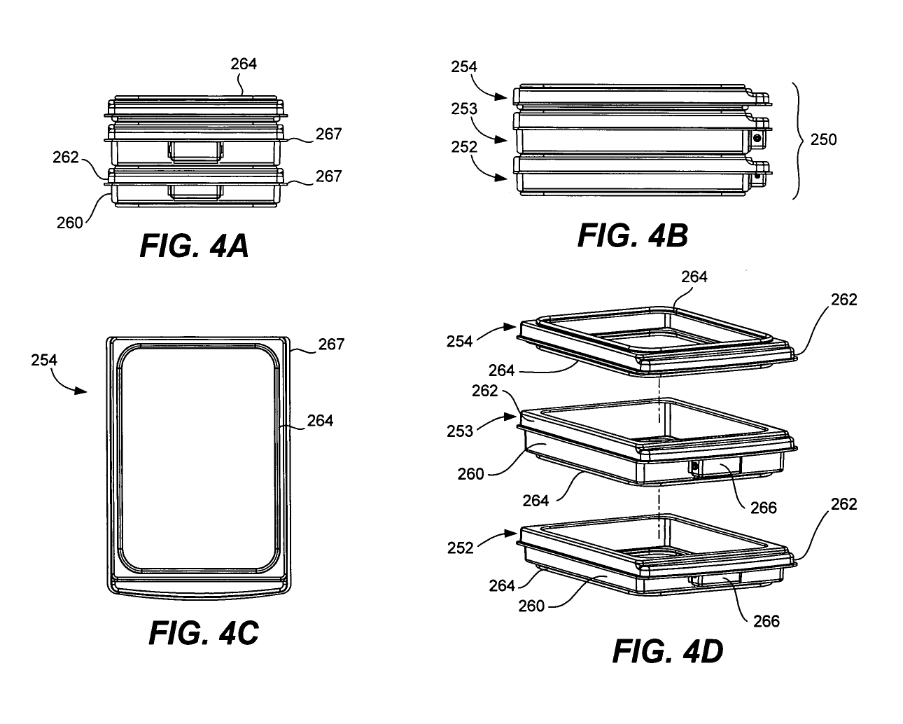

Turning next to FIGS. 4A-4B, embodiments of tray stacks will be briefly discussed. In the illustrated embodiment, each plasma reactor 105 includes a stack of three trays. A first (upstream) tray 252 includes a plasma generator. A second (middle) tray 253 includes electrostatic filters and a third (downstream) tray 254 includes one or more catalysts. The nature and functions of these components are described in some detail herein. Of course, in alternative embodiments, more or fewer trays could be provided as may be required and/or more or fewer components could be included in the plasma reactors.

Each of the trays 252-254 includes a box 260 and a lid 262 that covers the box. The depth of the box 260 may be varied depending on the thickness of the components housed therein. By way of example, it can be seen in FIG. 4B that in the illustrated embodiment, the box associated with downstream tray 254 is shallower than the box associated with the other trays. Of course, the depth of the boxes may be varied independently of one another. Moreover, the inventors point out that the lids are not absolutely necessary. In particular, when boxes are stacked upon each other and sealed together with the components sealed inside the lids are not strictly necessary in all embodiments.

The boxes 260 and the lids 262 each have side walls that are arranged in a generally rectangular configuration and the side walls of the lid are designed to fit relatively snugly over their associated boxes so that overlap between the lid and the side walls form a relatively airtight seal around the periphery of the trays. This helps to prevent air from entering or exiting the reactor through any gaps between the lids and the boxes. The side walls may also optionally include a latch mechanism to help prevent the lid 262 from unintentionally separating from the box 260. In alternative embodiments, the internal surface of the lid and/or the external surface of the boxes may be fitted with a seal or sealing structure in order to provide a good peripheral seal. In still other embodiments, the side walls of a lid and its associated box may be glued (as for example using a thermoset glue), hot platen welded, thermosonically welded, ultrasonically welded or otherwise bonded, welded or fused together to form the peripheral seal.

The box 260 has a bottom surface and the lid 262 has a top surface. The bottom surfaces of the boxes and the top surfaces of the lids each have a very large central opening. The central openings are preferably sized similarly and are aligned to form a central airflow path through the center of the reactor. Thus, the bottom surface of the box and the top surface of the lid are effectively simply peripheral rims as best seen in FIGS. 4C and 4D. The lids also have peripheral external lips 267. The function of the lips 267 was described in more detail in the discussions of FIG. 3.

Some of the trays (e.g., the plasma generator tray 252 and electrostatic filter tray 253 in the illustrated embodiment) are powered electrically. Accordingly, those trays are additionally outfitted with an electrical connector box 266 that houses an electrical coupler suitable for electrically connecting the electrically driven components within the trays (e.g., the electrodes in the plasma generators and the electrodes in the electrostatic filters) with external power supplies and/or control cabling. In the illustrated embodiment, the power supply and any required control cabling come from the electrical control box 205.

The trays may be formed from plastic or other suitable materials and may be formed in any suitable manner such as injection molding. In the illustrated embodiment, the lids 262 all have the same sizes and dimensions. Such standardization is desirable to help reduce manufacturing costs, but is not required.

As described above, it is generally desirable to seal the trays to minimize air leaks into or out of the reactor. Similarly, it is desirable to provide seals between adjacent trays so that leaks between the trays are minimized. Accordingly, seals 264 are provided on the outer surfaces of the end trays and between adjacent trays.

Returning briefly to FIG. 3, the trays are shown positioned in a lowered movable support bracket 101. In the illustrated embodiment, the plasma reactor 105 contained within trays 311, 312, 313 rests on the support tabs (301, 302, 303) of support bracket 101 until the bracket 101 is closed and sealed against the outlet duct 106 in the operating position. In this position the top of the tray (e.g., 254 of FIGS. 4B-4D, 201 of FIG. 2A) is sealed against the outlet duct 106. Seals 264 on the top surface of the downstream tray 254 are arranged to seal the interface between the duct and the reactor.

When, servicing or maintenance is complete, the plasma reactor is moved back into its operational position. These features can best be understood by referring back to FIGS. 2A-2D which depicts this feature. Referring first to FIG. 2A, the trays 211, 212, 213 and their associated components 221, 222, 223 are slid into place in the movable support bracket 101. Once seated and appropriately electrically connected as necessary, the bracket is raised from the lowered service position of FIG. 2A into the operating position (See, FIGS. 2B-2D). In the depicted embodiment, the movable support bracket 101 is pivotably attached to the fixed mounting bracket 102 using a hinge 101h. Accordingly, the movable support bracket 101 can be moved to the operating position by pivotably rotating the movable support bracket 101 (e.g., about hinge 101h) upward to the operating position where the components of the plasma reactor are placed proximal to the entrance of the outlet duct 106.

FIG. 2C depicts the bracket 101 and the trays 201, 202, 203 after being rotated into the operational position and in readiness for sealing. In this position the trays and reactor components are positioned such that they can be sealed together and sealed with the outlet duct 106 by a clamp mechanism.

As best seen in FIGS. 2D-2G, an extendable inlet duct 103 is pulled from a compressed position to its extended operating position (as shown for example in FIG. 2G). It is to be noted that the extendable inlet duct 103 has an outer frame 113 that supports the duct 103. The frame 113 can also include a seal enabling the duct to be sealed with the tray 213 when the duct is extended and the frame 113 is brought into contact with the tray 213. FIG. 2D depicts the inlet duct 103 after it has been extended toward the tray 213. Once the inlet duct 103 is fully extended, the frame 113 is sealed against the trays of the plasma reactor with clamping mechanism 270a, 270b. This clamping places enough force on the trays 211, 212, 213 and the frame 113 to seal them against one another to enable an airtight seal. Moreover, in the depicted embodiment, the clamping mechanism has a frame portion 270b and a mated bracket portion 270a mounted to the fixed bracket 102. In the depicted embodiment, the clamp components 270a, 270b are arranged to: (a) seal the inlet duct 103 frame 113 against the tray 213; (b) seal the trays 211, 212, 213, together; and (c) seal the trays against the outlet duct 106. The inventors point out that the features of the clamping mechanism can easily be switched around so that portion 270a is mounted to the inlet duct frame 113 and portion 270b is mounted to the bracket 102.

As shown, for example, in FIG. 2E, when the inlet duct 103 is fully extended into contact with the tray 213, the clamp can be actuated to seal the trays. In FIG. 2F, one portion 270b of the clamp mechanism is extended and inserted into the second component 270a of the clamp mechanism. As depicted in FIG. 2G the clamp portion 270b is pushed toward the inlet duct 103 to latch snugly with portion 270a thereby sealing the inlet duct 103,113 to the associated sealed trays. Simultaneously, the clamp seals the trays together and also seals the trays against the outlet duct 106. Thus, a sealed air path exists between the inlet duct 103, the trays 211, 212, 213, and the outlet duct 106 in which air flows into the system through the inlet duct 103 through the sealed trays and the associated plasma reactor and out through the sealed outlet duct 106 where it can be discharged as treated sterilized air into an air distribution system. In one implementation the distribution system is simply a plenum 107. In one example, the plenum can comprise a sealed enclosure having a vented bottom surface arranged to vent the treated air into the desired portions of the room 110. By way of example, the venting can be accomplished using a woven fabric surface of the bottom surface of the plenum 107 and the treated air is vented downward through the multitudinous holes that make up the fabric surface. The inventors point out that many latching mechanisms can be used in accordance with the principles of the invention. A typical descriptive example is found in U.S. patent Ser. No. 11/580,477, entitled “Air Decontamination and Purification Unit”, which is incorporated by reference herein for all purposes.

One of the difficulties in easily employing certain embodiments of the invention is the weight inherent in some plasma reactors as well as the pivotable access that is desirable for some embodiments of the invention. This makes some embodiments of the invention somewhat difficult to move and is at odds with the need to easily and comfortably lower the reactor into a service position allowing easy maintenance. Because lowering the plasma reactor into the operating room enables quicker and easier maintenance the inventors have constructed embodiments capable of more easily accomplishing this task. The inventors have added weight relieving support features to the system in order to more easily lower the plasma reactor and associated components into the maintenance position as well as assist in raising them back to the operating position as needed.

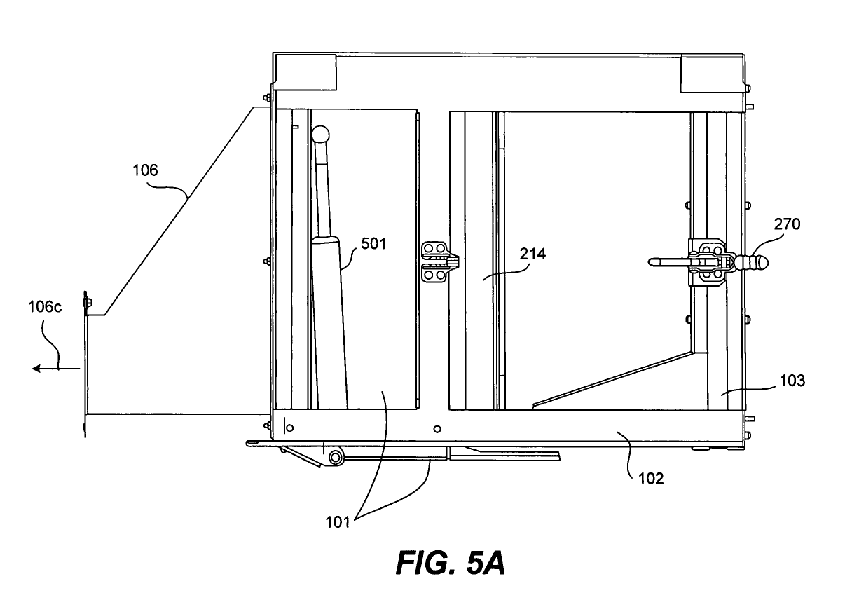

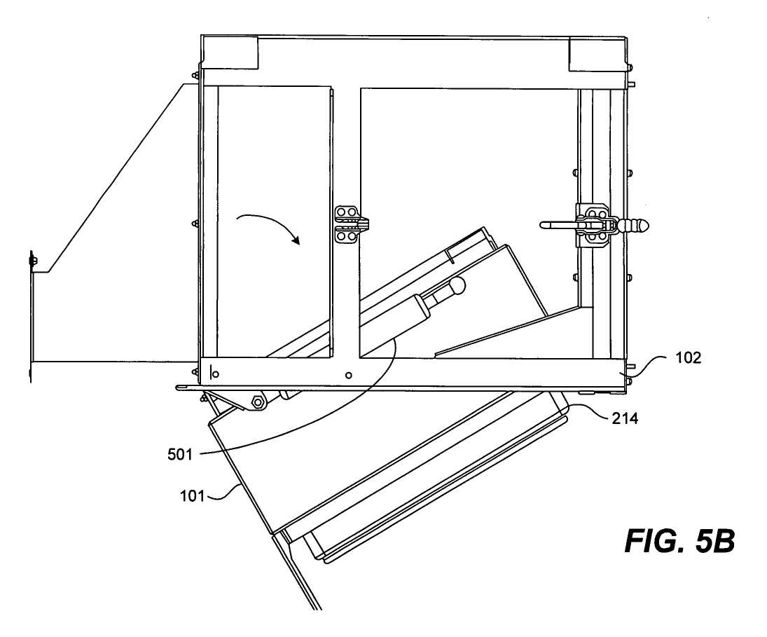

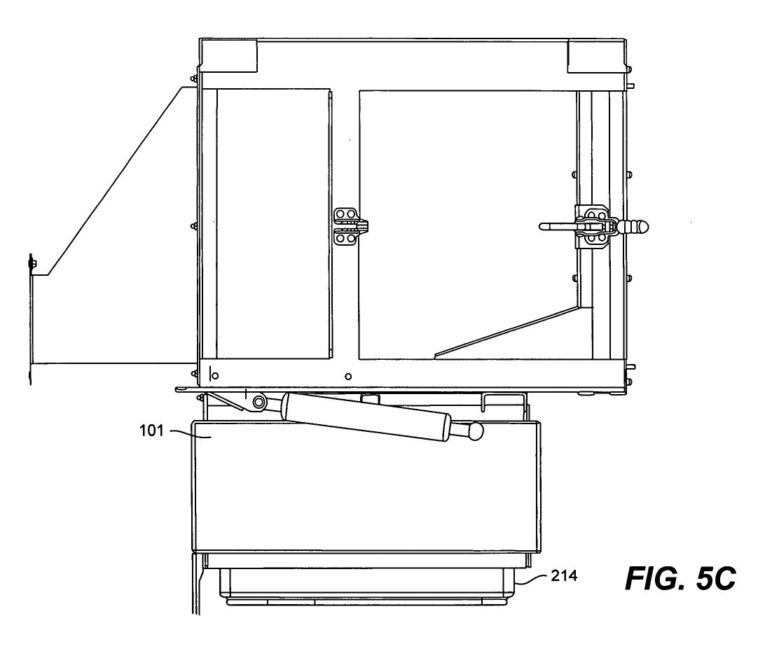

FIGS. 5A-5C depict an embodiment of a weight relieving mechanism constructed in accordance with the principles of the invention. In embodiments that have a pivotable support bracket that rotates a plasma reactor downward into a service position it can be advantageous to configure the system to offset some of the weight of the reactor as the bracket is raised and lowered.

FIG. 5A depicts an embodiment of the frame and support system used to support the plasma reactor in both service and operating positions. In FIG. 5A the reactor is depicted in the raised operational position. In this view, the retractable inlet duct 103 has been unclamped (270) and retracted so that the plasma reactor can be lowered from the raised operational position to the service position. The movable support bracket 101 supports the plasma reactor (shown here as contained within trays 214) in the raised position during use so that inflowing air can be introduced through the inlet duct 103 (which is expanded and sealed to the trays during use) into the reactor (e.g., trays 214) where it is treated and then discharges out through the outlet duct 106 as a flow of treated air 106c which is exhausted into a plenum (not shown in this view) for discharge into the desired portion of the room. Importantly, the movable support bracket 101 is further supported in the fixed mounting bracket 102 using a piston as the weight relieving mechanism. As the bracket 101 is lowered the piston 501 compresses to support some of the weight as depicted in FIG. 5B. The bracket 101 is lowered into the service position depicted in FIG. 5C. In this service position the bracket 101 and plasma reactor are suspended downward into the room for ready access and easy maintenance. The trays 214 can be easily removed (see for example FIG. 2A) and reactor components can be removed, cleaned, and/or replaced as needed.

In one embodiment of the invention, the piston is chosen such that it is in equilibrium with the bracket 101 (and reactor) as it is lowered (or raised) to and from the servicing position. Due to the changing angle of the bracket 101 as it is lowered (or raised) a changing torque is applied making management of the weight somewhat difficulty. Accordingly, the presence of a piston is used to reduce this effect. In fact in one embodiment, the piston is chosen such that as it is compressed it provides equilibrium points where the torque applied by the bracket and reactor is balanced against the resistance to compression supplied by the piston. In one particular embodiment, the type and position of the piston is chosen such that during piston compression the bracket torque is balanced to equilibrium by the piston. In another embodiment, the piston is balanced to equilibrium with the bracket such that the two equilibrium points are enabled. For example, in one embodiment the piston is chosen so that a first equilibrium is achieved when the moving support bracket 101 is lowered to a point just below the fixed mounting bracket 102. For example, the bracket and piston can be configured to enable a first equilibrium point just below the operating position where the supporting bracket is lowered to a position just below the operating position. In one embodiment, this first equilibrium position occurs when the bracket is rotated downwardly about 20-30° from the operating position. This will prevent a user from inadvertently dropping the full weight of the bracket and reactor down onto the user or otherwise damaging the reactor. The same piston can be configured to enable a second equilibrium position where the bracket 101 is nearly down into the servicing position (e.g. 90° as shown in FIG. 5C). In one example embodiment, the second equilibrium position can be arranged so that the supporting bracket is lowered to about 60-70° downward from the operating position. The piston 501 is arranged and configured so that in the equilibrium positions the piston supports substantially all of the weight of the plasma reactor (and also the movable bracket 101). The inventors point out that more than one piston can be employed to obtain a desired balancing with the suspended weight of the plasma reactor components and the lowered bracket. Additionally, the inventors also specifically contemplate that embodiments of a weight relieving support feature include more than just a piston apparatus. For example, the inventors contemplate that springs and combinations of springs, counter-weight systems, and other support systems will also support the weight of the plasma reactor and bracket 101.

Accordingly, although one particular method of supporting the weight of the bracket and plasma reactor is described, it should be appreciated that such support may take a wide variety of different forms beyond those specifically depicted in the illustrated embodiment and the unit may be installed using different approaches as well. In some circumstances, variations in the bracket geometry and operating mode may be necessitated by the design of the room or the design of the air treatment system. For example, the actual plasma reactor can be mounted outside the operating room with the plenum and treated air being vented into the operating room. Additionally, the size, location and shapes of the various components of the air treatment system, including the ducts 103, 106, the trays and associated reactor components 201, 202, 203, the power cables, the ports, the housing frame, etc. may all be widely varied from those illustrated in the drawings.

As indicated above and as will be appreciated by those familiar with air purification systems in general, it is highly desirable to periodically clean or service such units. It should be apparent that the described air-treatment unit embodiments can be readily accessed for cleaning and/or maintenance and easily reinstalled after such cleaning or maintenance. This provides a significant advantage over air-treatment systems that require more extensive efforts to install and/or remove a unit in terms of both (1) the time and effort required to clean and/or maintain the unit; and (2) the accompanying disincentive to actually clean the unit on a regular basis.

Moreover, it is noted that in some situations there may be residual amounts of solvent left on the various components of the air treatment unit after cleaning. Accordingly, there is some chance that residual solvents may become entrained in the air stream as volatile organic compounds. A fortunate side benefit of using the plasma reactors 105 as described above is that they can eliminate a majority of any volatile organic compounds passing there through, including residual solvents used to clean the components of the air treatment system.

The inventors contemplate that the advantageous drop down maintenance features disclosed in many of the embodiments described here can be used to facilitate the easy maintenance of many different types of air treatment units. By way of example, plasma reactors, ion enhanced electrostatic filters, UV based air treatment systems, mechanical HEPA or ULPA filters, or a variety of other devices may be used to treat the air.

Although only a few embodiments of the invention have been described in detail, it should be appreciated that the invention may be implemented in many other forms without departing from the spirit or scope of the invention. For example, the novel plasma reactor design is formed from a stack of compressed trays as described. It should be apparent that the described compressed tray stack can be used in a wide variety of applications well beyond the ceiling mounted air treatment system described. Indeed the compressed tray stack arrangement can be used in a wide variety of other air treatment systems. Also, the described compressed tray stacks may be used to house a wide variety of air treatment components in place of or in addition to the described plasma reactors.

Therefore, the present embodiments should be considered illustrative and not restrictive and the invention is not to be limited to the details given herein, but may be modified within the scope and equivalents of the appended claims.

What is claimed is:

1. An in-ceiling air-treatment system comprising:
an inlet duct that receives an air stream from a central air handling system;
an outlet duct for discharging a treated air stream;
a plasma reactor disposed between the inlet duct and the outlet duct, the reactor arranged in the air stream from the inlet duct enabling the plasma reactor to filter and biologically decontaminate the air stream passing therethrough and discharging the treated air stream from the outlet duct;
a plenum coupled to the outlet of the plasma reactor and arranged to receive at least a part of the treated air stream that has passed through the plasma reactor of the air treatment unit and to discharge the treated air stream into the a room,
wherein the inlet duct, the plasma reactor, the outlet duct, and the plenum, are located in the ceiling of a room thereby enabling the treated air stream to be discharged into the room.

2. An in-ceiling air-treatment system as recited in claim 1 wherein the plasma reactor includes a plasma generator arranged to create reactive species in the air stream passing through the plasma reactor, an electrostatic filter located downstream from the plasma generator, and at least one catalyst located downstream from the electrostatic filter that is arranged to remove reactive species that remain in the air stream after passing through the electrostatic filter.

3. An in-ceiling air-treatment system as recited in claim 2 wherein the plasma reactor is carried on a frame than enables the plasma reactor to be moved from an operating position within the ceiling of the room to a servicing position where it can be more readily accessed for servicing from within the room.

4. An in-ceiling air-treatment system as recited in claim 3 wherein the servicing position is arranged so that the plasma reactor extends down from the ceiling into the room where it can more readily be accessed for servicing.

5. An in-ceiling air treatment system comprising:
an air-treatment unit that filters and purifies an air stream passing therethrough to treat the air for delivery into the a room associated with a ceiling that houses the air treatment system;
a frame that supports the air-treatment unit, the frame enabling the movement of the air-treatment unit from an operating position that positions the air-treatment unit at a location within the ceiling of the room and a servicing position that positions the air-treatment unit at a location substantially within the room where it can more readily be accessed for servicing from within the room.

6. An in-ceiling air-treatment system as recited in claim 5 wherein the frame includes a movable support bracket that is pivotably mounted to a fixed mounting bracket that can be mounted in a ceiling, the movable support bracket pivotably operates with the fixed support bracket to enable the air treatment unit to be rotated downward from its operating position to a servicing position within the room.

7. An in-ceiling air-treatment system as recited in claim 6 wherein the air-treatment unit includes a plasma reactor

8. An in-ceiling air-treatment system as recited in claim 6 wherein the frame includes a weight relieving support feature that supports the at least some of the weight of the air-treatment unit and support bracket as the movable support bracket is pivotably raised into the operating position or pivotably lowered into the servicing position.

9. An in-ceiling air-treatment system as recited in claim 8 wherein the weight relieving support feature is configured to enable a first equilibrium position and a second equilibrium position such that at each equilibrium position the weight relieving support feature supports substantially all of the weight of the air-treatment unit and movable support bracket.

10. An in-ceiling air-treatment system as recited in claim 8 wherein the weight relieving support feature enables a first equilibrium position that supports substantially all of the weight of the air-treatment unit as the support frame is initially pivotably lowered from the ceiling operating position and configured to enable a second equilibrium position that supports substantially all of the weight of the air treatment unit when the support frame is opened to a point just above the servicing position

11. An in-ceiling air-treatment system as recited in claim 8 wherein the weight relieving support feature includes pistons arranged to enable said support of at least some of the weight of the air-treatment unit and support bracket as the support bracket is pivotably raised or lowered.

12. An in-ceiling air-treatment system as recited in claim 8 wherein the weight relieving support feature includes spring loaded system arranged to enable said support of at least some of the weight of the air- treatment unit and support bracket as the support bracket is pivotably raised or lowered.

13. An in-ceiling air-treatment system as recited in claim 6 wherein elements of the air treatment unit are arranged in a plurality stacked trays configured so that they can support air-treatment unit components inside the tray and also enable substantial airflow to pass through each component and each tray.

14. An in-ceiling air-treatment system as recited in claim 13 wherein elements of the air-treatment unit comprise a plasma reactor that is arranged in the plurality stacked trays configured so that they can support reactor component elements inside the tray and also enable substantial airflow to pass through the components and the trays.

15. An air-treatment system as recited in claim 14 wherein the stacked trays include a first tray holding a plasma generator and a second tray located holding an electrostatic filter with the second tray being positioned downstream from the first tray.

16. An air-treatment system as recited in claim 15 wherein the stacked trays further include a third tray located downstream from the second tray, the third tray including a catalyst that reduces the amount of reactive species in the treated air stream.

17. An air-treatment system as recited in claim 15 wherein the stacked trays further include a fourth tray located upstream from the first catalyst, the fourth tray including a second catalyst comprising an oxidation catalyst that increases the amount of reactive species in the treated air stream.

18. An in-ceiling air-treatment system as recited in claim 13 wherein the fixed frame includes a clamp that operates to clamp the stacked trays together to seal the stacked trays when the clamp is engaged.

19. An in-ceiling air-treatment system as recited in claim 14 wherein the fixed frame includes a clamp that operates to clamp the stacked trays together to seal the stacked trays when the clamp is engaged.

20. An in-ceiling air-treatment system as recited in claim 19 wherein the air-treatment system includes:
an air inlet duct that is engaged with the trays that hold the plasma reactor, the inlet duct for receiving an air inflow from an airflow system and enabling that airflow to pass into the plasma reactor for treatment; and
an air outlet duct that is engaged with the trays at that hold the plasma reactor, the outlet duct for receiving treated air from the plasma reactor and for discharging the treated air as an outflow air stream.

21. An in-ceiling air-treatment system as recited in claim 20 wherein the clamp further operates to clamp the stacked and sealed trays against the air outlet duct and against the air inlet duct defining a sealed air flow path through the inlet duct, the stacked trays, and the outlet duct.

22. An in-ceiling air-treatment system as recited in claim 19 wherein the air-treatment system includes a plenum arranged to receive the treated outflow air stream from the plasma reactor, the plenum discharging treated air into a desired clean environment.

23. An in-ceiling air-treatment system as recited in claim 20 wherein the air inlet duct is a retractable duct that is configured to enable the inlet duct to be extended toward the trays when the trays are in the operating position such that the duct is sealed together with the trays and plasma reactor when clamped to enable a sealed airflow to pass through the plasma reactor and wherein the air inlet duct is further configured so that it can be unclamped from the trays and retracted from the sealed position to enable the trays and plasma reactor components to be lowered into a servicing position for maintenance.

24. A clean room having an in-ceiling air treatment system, the room comprising:
a room having a ceiling and walls;
an air-treatment system mounted in the ceiling, the air treatment system including:
a plenum for discharging treated air into the room;
a central air system for providing an inflowing airflow;
a frame arranged to support an inlet duct, an outlet duct, and enable operation of a movable plasma reactor, the frame including:
a fixed mounting bracket secured to the ceiling;
an inlet duct for receiving the inflowing airflow from the central air system;
an outlet duct for discharging treated air from the plasma reactor to the plenum which discharges air downwardly from the ceiling;
a movable support bracket that is pivotably attached to the fixed mounting bracket and supports the plasma reactor, the movable support bracket configured so that in an operational position the plasma reactor is mounted in the ceiling so that it can receive the inlet airflow from the central air system through the inlet duct and so that it can discharge treated air into the plenum through the outlet duct and the movable support bracket further configured so that it can be readily moved to a service position enabling the plasma reactor to be moved into a position lying inside the room enabling easy access to the plasma reactor from inside the room.

25. The clean room recited in claim 24 wherein the plasma reactor includes a plasma generator arranged to create reactive species in an air stream passing through the plasma reactor, an electrostatic filter located downstream of the plasma generator, at least one catalyst located downstream of the electrostatic filter that is arranged to remove reactive species that remain in the air stream after passing through the electrostatic filter, and a plurality of stacked trays that have openings opposing tray ends, all arranged such that trays fit into the movable support bracket and such that the plasma generator is mounted in a first tray, the electrostatic filter is mounted in a second tray positioned downstream from the first tray, and the catalyst is mounted in a third tray positioned downstream from the second tray, and when the support bracket positions the plasma reactor into the operational position, the plurality of trays are clamped together to seal the plasma reactor and enabling the airflow to pass from the input duct through the trays and the plasma reactor and through the output duct into the plenum where it is discharged into the room.

26. The clean room recited in claim 24 wherein the movable support bracket includes a weight relieving support feature that supports the at least some of the weight of the plasma reactor and the support bracket as the movable support bracket is pivotably raised into the operating position or pivotably lowered into the servicing position.

27. The clean room recited in claim 25 wherein the movable support bracket includes a set of support tabs for each of the plurality of trays, each set of support tabs arranged to support an associated tray of the plasma reactor in a spaced apart arrangement when the movable support bracket is moved downward into the servicing position enabling each tray to be slidably removed from the movable support bracket.

28. The clean room recited in claim 25 wherein the room comprises an operating room that includes an operating table suitable for surgical procedures and wherein the plenum is arranged to direct the flow of treated air downward onto the operating table.

29. The clean room recited in claim 24 wherein the room comprises a semiconductor wafer processing clean room.
